(19) United States
(12) Patent Application Publication
(10) Pub. No.: US 2026/0057279 A1
(43) Pub. Date: Feb. 26, 2026

(54) UTILIZING A LOSS FUNCTION TO MINIMIZE QUANTUM INFORMATION GAP

(71) Applicant: BOARD OF TRUSTEES OF THE UNIVERSITY OF ARKANSAS, Little Rock, AR (US)

(72) Inventors: Khoa Luu, Fayetteville, AR (US); Xuan Bac Nguyen, Fayetteville, AR (US)

(73) Assignee: BOARD OF TRUSTEES OF THE UNIVERSITY OF ARKANSAS, Little Rock, AR (US)

(21) Appl. No.: 19/305,026

(22) Filed: Aug. 20, 2025

Related U.S. Application Data
(60) Provisional application No. 63/684,994, filed on Aug. 20, 2024.

(51) Int. Cl. G06N 10/60; G06V 40/16

(52) U.S. Cl. CPC G06N 10/60; G06V 40/16

(57) ABSTRACT

A method, system, and computer program product for minimizing a quantum information gap. Classical features are projected into logits. Furthermore, quantum features are projected into logits using quantum center vectors. A loss function measuring how well a model's prediction aligns with true labels is calculated using the logits of the classical features and a set of labels. Furthermore, an expression is calculated that minimizes an average Kullback-Leibler divergence between projected feature distributions from two different modalities or sources using the logits of the classical features and the logits of the quantum features. Additionally, the quantum information preserving loss function used to train a model to minimize the quantum information gap is calculated using the loss function, the expression, and a loss factor. After training the model, the trained model produces a feature vector, which preserves the important information and patterns present in the original classical feature vector.

### TECHNICAL FIELD

The present disclosure relates generally to quantum encoding, and more particularly to reducing the quantum information gap (gap of information between classical and corresponding quantum features) by utilizing a loss function to minimize the quantum information gap resulting in enhanced performance of quantum machine learning algorithms.

### BACKGROUND

Quantum machine learning represents a promising research direction at the intersection of quantum computing and artificial intelligence. Within this realm, the utilization of quantum computers promises to significantly boost machine learning algorithms by leveraging their innate parallel attributes thereby showcasing quantum advantages that surpass classical algorithms.

Due to the substantial collaborative endeavors of academia and industry, contemporary quantum devices, often referred to as noisy intermediate-scale quantum (NISQ) devices, are now capable of demonstrating quantum advantages in specific meticulously crafted tasks. Emerging research focuses in leveraging near-term quantum devices for practical machine learning applications, with a prominent approach being hybrid quantum-classical algorithms, also referred to as variational quantum algorithms. These algorithms typically employ a classical optimizer to refine quantum neural networks (QNNs) by allocating complex tasks to quantum computers while assigning simpler tasks to classical computers.

In typical quantum machine learning scenarios, a quantum circuit utilized in variational quantum algorithms is commonly divided into two components: a data encoding circuit and a QNN. Enhancing these algorithms' efficacy in handling practical tasks involves the development of various QNN architectures. Numerous architectures, including strongly entangling circuit architectures, tree-tensor networks, quantum convolutional neural networks, and even automatically searched architectures, have been proposed. Furthermore, enhancing the algorithms' efficiency in handling practical tasks involves the careful design of the encoding circuit as it can significantly impact the generalization performance of these algorithms.

Encoding classical information into quantum data is a crucial step as it directly impacts the performance of quantum machine learning algorithms. These algorithms are designed to optimize objective functions, such as classification, using encoded data. However, quantum encoding poses significant challenges, especially on near-term quantum devices, as highlighted in previous research.

While phase and amplitude encoding are foundational approaches, recent advancements have popularized parameterized quantum circuits (PQCs) as the most practical strategy for encoding on NISQ devices. Nevertheless, despite the prevalence of PQCs, it is essential to utilize the basic encoding methods, such as phase and amplitude encoding, at the first step due to simplicity and accessibility, reduced hardware demands, and targeted encoding. Phase and amplitude encoding are fundamental techniques in quantum computing for representing classical data into quantum states, which is referred to as “quantum encoding.” Quantum encoding is the process of transforming classical data (e.g., numbers, text, images) into a quantum state, which is a superposition of 0s and 1s represented by qubits. These encodings (phase and amplitude encoding) leverage the properties of quantum superposition and entanglement to potentially offer advantages in computational speed and efficiency compared to classical methods.

Unfortunately, such encoding strategies (e.g., phase and amplitude encoding) when used in connection with quantum visual encoding, which focuses on transforming complex visual data into a form that can be effectively processed by quantum algorithms, fail to guarantee the preserving of the fundamental properties or characteristics of the classical data in its quantum form. That is, existing quantum encoding strategies (e.g., phase and amplitude encoding) fail to ensure information preservation of the visual features after the encoding process, thus complicating the learning process of the quantum machine learning models resulting in a quantum information gap (QIG), i.e., a gap of information between classical and corresponding quantum features.

### SUMMARY

In one embodiment of the present disclosure, a method for minimizing a quantum information gap comprises receiving a set of images. The method further comprises extracting classical features from the set of images. The method additionally comprises transforming the classical features into quantum features. Furthermore, the method comprises transforming the classical features into quantum center vectors. Additionally, the method comprises projecting the classical features into logits. In addition, the method comprises projecting the quantum features into logits using the quantum center vectors. The method further comprises calculating a loss function measuring how well a model's prediction aligns with true labels using the logits of the classical features and a set of labels. The method additionally comprises calculating an expression that minimizes an average Kullback-Leibler divergence between projected feature distributions from two different modalities or sources using the logits of the classical features and the logits of the quantum features. Furthermore, the method comprises computing a quantum information preserving loss function to train a model to minimize the quantum information gap using the loss function, the expression, and a loss factor for controlling how much information is preserved.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for minimizing the quantum information gap using the quantum information preserving loss function in accordance with an embodiment of the present disclosure;

FIG. 3 illustrates an embodiment of the present disclosure of the hardware configuration of the classical computer which is representative of a hardware environment for practicing the present disclosure; and

FIG. 4 is a flowchart of a method for minimizing the quantum information gap in accordance with an embodiment of the present disclosure.

### DETAILED DESCRIPTION

As stated above, due to the substantial collaborative endeavors of academia and industry, contemporary quantum devices, often referred to as noisy intermediate-scale quantum (NISQ) devices, are now capable of demonstrating quantum advantages in specific meticulously crafted tasks. Emerging research focuses in leveraging near-term quantum devices for practical machine learning applications, with a prominent approach being hybrid quantum-classical algorithms, also referred to as variational quantum algorithms. These algorithms typically employ a classical optimizer to refine quantum neural networks (QNNs) by allocating complex tasks to quantum computers while assigning simpler tasks to classical computers.

In typical quantum machine learning scenarios, a quantum circuit utilized in variational quantum algorithms is commonly divided into two components: a data encoding circuit and a QNN. Enhancing these algorithms' efficacy in handling practical tasks involves the development of various QNN architectures. Numerous architectures, including strongly entangling circuit architectures, tree-tensor networks, quantum convolutional neural networks, and even automatically searched architectures, have been proposed. Furthermore, enhancing the algorithms' efficiency in handling practical tasks involves the careful design of the encoding circuit as it can significantly impact the generalization performance of these algorithms.

Encoding classical information into quantum data is a crucial step as it directly impacts the performance of quantum machine learning algorithms. These algorithms are designed to optimize objective functions, such as classification, using encoded data. However, quantum encoding poses significant challenges, especially on near-term quantum devices, as highlighted in previous research.

While phase and amplitude encoding are foundational approaches, recent advancements have popularized parameterized quantum circuits (PQCs) as the most practical strategy for encoding on NISQ devices. Nevertheless, despite the prevalence of PQCs, it is essential to utilize the basic encoding methods, such as phase and amplitude encoding, at the first step due to simplicity and accessibility, reduced hardware demands, and targeted encoding. Phase and amplitude encoding are fundamental techniques in quantum computing for representing classical data into quantum states, which is referred to as “quantum encoding.” Quantum encoding is the process of transforming classical data (e.g., numbers, text, images) into a quantum state, which is a superposition of 0s and 1s represented by qubits. These encodings (phase and amplitude encoding) leverage the properties of quantum superposition and entanglement to potentially offer advantages in computational speed and efficiency compared to classical methods.

Unfortunately, such encoding strategies (e.g., phase and amplitude encoding) when used in connection with quantum visual encoding, which focuses on transforming complex visual data into a form that can be effectively processed by quantum algorithms, fail to guarantee the preserving of the fundamental properties or characteristics of the classical data in its quantum form. That is, existing quantum encoding strategies (e.g., phase and amplitude encoding) fail to ensure information preservation of the visual features after the encoding process, thus complicating the learning process of the quantum machine learning models resulting in a quantum information gap (QIG), i.e., a gap of information between classical and corresponding quantum features.

The embodiments of the present disclosure provide an efficient new loss function (referred to herein as the “quantum information preserving (QIP)” loss function) to minimize the quantum information gap resulting in enhanced performance of quantum machine learning algorithms. Through empirical experiments conducted on various large-scale datasets, the effectiveness of the approach of the present disclosure in achieving state-of-the-art performance in clustering problems on quantum machines has been demonstrated.

Furthermore, embodiments of the present disclosure provide an efficient novel training approach to generate classical features conducive to quantum machines post-encoding resulting in substantially enhancing quantum machine learning algorithms.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

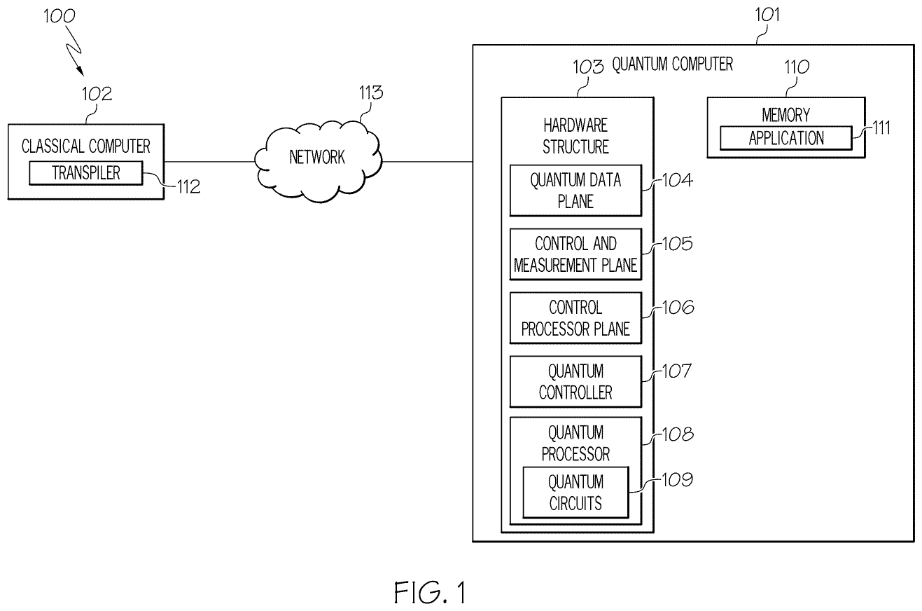

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to minimize the quantum information gap (gap of information between classical and corresponding quantum features) using a loss function (referred to herein as the quantum information preserving loss function).

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, where X is the Pauli-X matrix, which corresponds to a rotation of the qubit state around the X-axis by the given angle theta (θ) on the Bloch sphere), RY (also identified as Ry) (performs e^{iθY/2}, where Y is the Pauli-Y matrix, which corresponds to a rotation of the qubit state around the Y-axis by the given angle theta (θ) on the Bloch sphere), RXX (performs the operation e^{(-iθX⊗X/2)} on the input qubit), RZZ (takes in one input, an angle theta (θ) expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

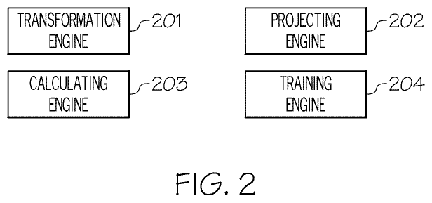

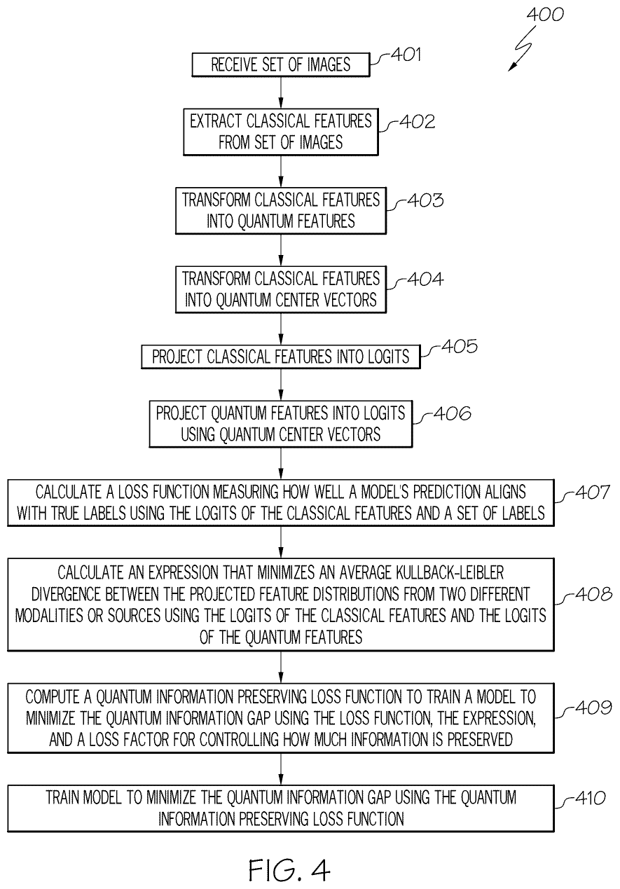

In one embodiment, memory 110 stores an application 111 that may be configured to implement one or more of the methods described herein in accordance with one or more embodiments. For example, application 111 may implement a program for minimizing the quantum information gap (gap of information between classical and corresponding quantum features) using a loss function (referred to herein as the quantum information preserving loss function) as discussed below in connection with FIGS. 2 and 4. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, a cellular network, and various combinations thereof, etc. Other networks, whose descriptions are omitted here for brevity, may also be used in conjunction with system 100 of FIG. 1 without departing from the scope of the present disclosure.

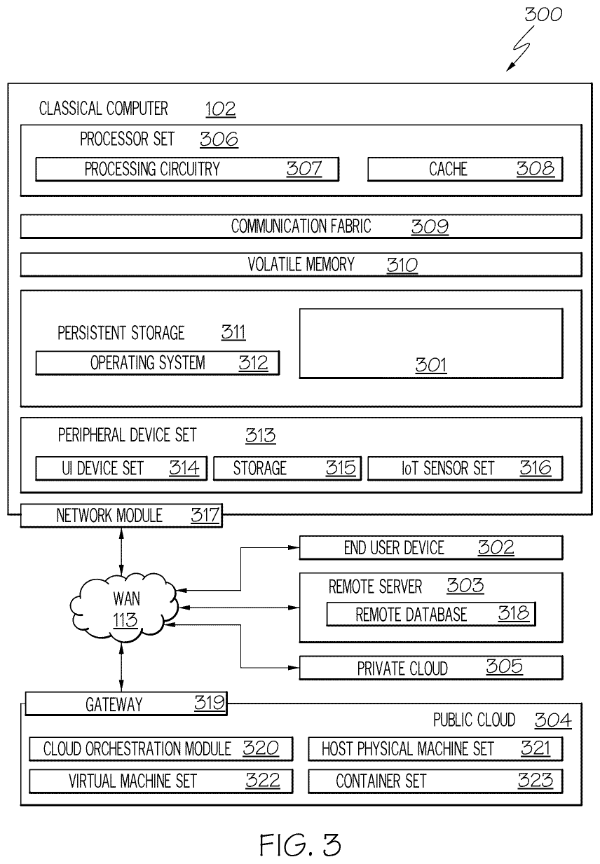

Furthermore, classical computer 102 is configured to minimize the quantum information gap (gap of information between classical and corresponding quantum features) using a loss function (referred to herein as the quantum information preserving loss function) as discussed below in connection with FIGS. 2 and 4. A description of the software components of classical computer 102 is provided below in connection with FIG. 2 and a description of the hardware configuration of classical computer 102 is provided further below in connection with FIG. 3.

System 100 is not to be limited in scope to any one particular network architecture. System 100 may include any number of quantum computers 101, classical computers 102, and networks 113.

A discussion regarding the software components used by classical computer 102 for minimizing the quantum information gap (gap of information between classical and corresponding quantum features) using a loss function (referred to herein as the quantum information preserving loss function) is provided below in connection with FIG. 2.

FIG. 2 is a diagram of the software components of classical computer 102 (FIG. 1) for minimizing the quantum information gap (gap of information between classical and corresponding quantum features) using a loss function (referred to herein as the quantum information preserving loss function) in accordance with an embodiment of the present disclosure.

Referring to FIG. 2, in conjunction with FIG. 1, classical computer 102 includes transformation engine 201 configured to receive a set of images. In one embodiment, the images include photographs, videos, or combinations thereof. In one embodiment, the images include facial expressions. In one embodiment, the images include a landscape. In one embodiment, the set of images is captured through a camera.

In one embodiment, transformation engine 201 extracts the classical features (vᵢ) from the set of images. Classical features, as used herein, refer to the characteristics (e.g., edges, textures, shapes, corners, etc.) captured from the set of images.

In one embodiment, transformation engine 201 extracts such classical features using the histogram of oriented gradients, which captures the distribution of edge orientations to represent shape and appearance. In one embodiment, such a process involves dividing the images into cells, computing gradients, creating orientation histograms, and normalizing them in blocks to form a feature vector.

In another embodiment, transformation engine 201 extracts such classical features using local binary patterns, which describe local texture patterns. In one embodiment, such a process involves comparing a center pixel to its neighbors, assigning binary values, converting patterns to decimal numbers, and creating a histogram.

In another embodiment, transformation engine 201 extracts such classical features using a gray level co-occurrence matrix, which analyzes spatial relationships between pixels by counting intensity value pairs at defined distances and angles. In one embodiment, such a process involves converting the image to grayscale, creating and normalizing a co-occurrence matrix, and extracting the statistical features (e.g., contrast, energy).

In a further embodiment, transformation engine 201 extracts such classical features using a scale-invariant feature transform (SIFT) and speeded-up robust features (SURF), which are algorithms that detect and describe local features (keypoints) resistant to scale, rotation, and illumination changes. In one embodiment, such a process involves detecting keypoints, assigning orientation, creating descriptors, and matching descriptors between images.

Furthermore, in one embodiment, transformation engine 201 transforms the extracted classical features into quantum features (qᵢ) as well as quantum center vectors(S). Quantum features, as used herein, refer to the unique characteristics of the quantum mechanical realm, including wave-particle duality, superposition, entanglement, and quantized energy levels. Quantum center vectors, as used herein, refer to elements within the center of a quantum algebra or quantum group.

In one embodiment, transformation engine 201 transforms the extracted classical features into quantum features by utilizing a quantum feature map, which is a quantum circuit designed to encode classical data into quantum states. In one embodiment, transformation engine 201 utilizes the basis encoding scheme, which represents each feature with a qubit, mapping binary features directly to computational basis states (e.g., 0 to |0 [symbol] , 1 to |1 [symbol] ).

In one embodiment, transformation engine 201 utilizes the amplitude encoding scheme, which encodes the classical feature vector into the amplitudes of the quantum state.

In another embodiment, transformation engine 201 utilizes the angle encoding scheme, which uses rotation gates (Rx, Ry, Rz) where the rotation angles are determined by the classical feature values.

In a further embodiment, transformation engine 201 utilizes parameterized quantum circuits, which utilize trainable unitary transformations to evolve quantum states, capturing complex feature relationships and representing data in high-dimensional quantum spaces.

In one embodiment, transformation engine 201 then builds the quantum circuit, such as by selecting the appropriate gates and sequencing them to implement the chosen encoding scheme. Transformation engine 201 may utilize various software tools for building the quantum circuit, including, but not limited to, Qiskit®, PennyLane®, Cirq®, etc.

In one embodiment, transformation engine 201 transforms the extracted classical features into quantum features (qᵢ) by performing [symbol] (vᵢ, [symbol] ) where it defines a function Q that maps a classical data point v into a quantum feature q, represented by a quantum state in Hilbert space. The parameters [symbol] and [symbol] represent the encoding strategy or the specific quantum operations used for the transformation.

In one embodiment, transformation engine 201 transforms the extracted classical features into quantum center vectors by utilizing kernel-based quantum machine learning. For example, quantum features may be represented and leveraged through quantum kernel methods. Quantum kernels measure the similarity between quantum states.

In one embodiment, transformation engine 201 implements a kernel trick which allows calculating these similarities (inner products) in a high-dimensional quantum feature space without explicitly computing the coordinates of each quantum state.

In one embodiment, transformation engine 201 then implements a quantum kernel estimation, which involves estimating the values of the quantum kernel function using quantum circuits, for example, using a sweep test or Hadamard test to measure the overlap between quantum states.

In one embodiment, transformation engine 201, within this framework, defines the quantum center vectors as the centroids of clusters or the representatives of different classes in the quantum feature space. These are then used in quantum clustering or classification algorithms.

In one embodiment, transformation engine 201 transforms the extracted classical features into quantum center vectors(S) by performing [symbol] (W, [symbol] ) using the same Q function. In one embodiment, W refers to a set of weights or parameters used to define these center vectors in the classical domain before they are transformed into quantum features.

Classical computer 102 further includes projecting engine 202 configured to project the classical features into logits (raw prediction scores). Logits, as used herein, refer to the raw, unnormalized scores from the model, representing the model's initial predictions before being transformed into probabilities.

In one embodiment, projecting engine 202 projects the classical features into logits (wᵢ) by applying a linear transformation (W^{T}) of the classical features (vᵢ) and then normalizing them using the Softmax function. In one embodiment, W represents a weight matrix (or a set of weights) that the model learns during training. In one embodiment, the linear transformation involves matrix multiplication effectively combining the input features with the learned weights to produce raw scores (logits) for each possible class. In one embodiment, the softmax function converts these logits into a probability distribution over the classes. In one embodiment, the outputs are between 0 and 1 and sum up to 1, representing the probability of the input belonging to each class.

Furthermore, in one embodiment, projecting engine 202 is configured to project the quantum features (qᵢ) into logits (uᵢ) using the quantum center vectors(S). In one embodiment, projecting engine 202 performs the calculation (S^{T} qᵢ), such an inner product calculation, between the quantum center vectors(S) and the quantum feature of the input qᵢ to measure the similarity or closeness of the input data point's quantum features to each of the quantum center vectors.

In one embodiment, projecting engine 202 feeds the result of (S^{T} qᵢ) into a Softmax function, which converts a set of scores (logits, which are the outputs of (S^{T} qᵢ)) into a probability distribution, where each value represents the probability that the input vᵢ belongs to one of the classes based on its similarity to the corresponding quantum center vector. The output uᵢ will be a vector of these probabilities.

Additionally, classical computer 102 includes calculating engine 203 configured to calculate a loss function ( [symbol] ) measuring how well a model's predictions align with the true labels using the logits (wᵢ) of the classical features and a set of labels ( [symbol] ). True labels, as used herein, refer to the actual correct classifications or values associated with each data point in a dataset. In one embodiment, calculating engine 203 calculates such a loss function ( [symbol] ) by computing the following equation:

$$\frac{1}{N} {\sum }_{i = 1}^{N} - log {w}_{i , {\hat{y}}_{i}} .$$

In one embodiment,

$$- log {w}_{i} , {\hat{y}}_{i} .$$

is the negative logarithm of the predicted probability for the correct class ( [symbol] ) for the i-th image. That is, if the model predicts the correct class with high probability (closer to 1), then-log (probability) will be close to 0 (lower loss). In contrast, if the model predicts the correct class with low probability, then the loss will be high.

In one embodiment, calculating engine 203 computes the average of the negative log-probabilities over all N samples.

In one embodiment, the cross-entropy loss (the loss computed using the negative logarithm of the predicted probabilities) is used to quantify the error between the predictions and the actual labels thereby aiming to minimize this loss during training.

In one embodiment, calculating engine 203 calculates an expression ( [symbol] ) that minimizes an average Kullback-Leibler (KL) divergence between the projected feature distributions from two different modalities or sources using the logits (wᵢ) of the classical features and the logits (uᵢ) of the quantum features. In one embodiment, such an expression is computed by calculating engine 203 using the following formula:

$$← \frac{1}{N} {\sum }_{i = 1}^{N} {\sum }_{\vert j = 1}^{C} {w}_{i , j} log \frac{{w}_{i , j}}{{w}_{i , j}} .$$

In one embodiment, the KL divergence measures how one probability distribution differs from a second, reference probability distribution. For example, such probability distributions correspond to wᵢ and uᵢ.

Furthermore, calculating engine 203 performs an averaging operation over N samples or instances as well as indicates a summation over c classes or categories within each sample's probability distribution.

Additionally, calculating engine 203 calculates the average KL divergence over a dataset (i=1 to N). In one embodiment, calculating engine 203 compares the probability distribution produced by applying the softmax function (discussed further below) to a set of learned weights (W^{T}vᵢ) with a reference probability distribution derived from the quantum information vectors (S^{T}qᵢ). By minimizing the KL divergence, the model aims to make its predicted distribution as close as possible to the target distribution (Q), which is influenced by the quantum information vectors derived from Wⱼ. That is, the model is attempting to align its classical machine learning predictions with the quantum properties represented by Sⱼ and Wᵢ.

In one embodiment, calculating engine 203 computes a quantum information preserving loss function ( [symbol] |_{QIP}) to train a model to minimize the quantum information gap using the loss function ( [symbol] ), the expression ( [symbol] ), and the loss factor for controlling how much information is preserved. In one embodiment, the quantum information preserving loss function is calculated using the following:

$${ℒ}_{QIP} ← ℒ + λ$$

In one embodiment, calculating engine 203 computes a quantum information preserving loss function ( [symbol] |_{QIP}) using the components of the metric loss [symbol] and the scaled KL divergence λ [symbol] .

As a result, the quantum information preserving loss function aims to optimize the model's performance in two ways: metric matching and quantum information preservation. Metric matching involves the metric loss term which ensures that the model's predictions align with the true labels. Quantum information preservation involves the KL divergence term, which encourages the model to maintain a resemblance to a predefined “quantum information preserving” distribution represented by Sⱼ.

In one embodiment, the weighting factor, λ, controls the balance between these two objectives.

Classical computer 102 additionally includes training engine 204 configured to train the model to minimize the quantum information gap using the quantum information preserving loss function.

In one embodiment, training engine 204 defines a quantum model. In one embodiment, the quantum model is defined by constructing a parameterized quantum circuit or a variational quantum neural network using a library, such as PennyLane®, Qiskit®, Cirq®, etc. In one embodiment, the model takes quantum states or classical data encoded as quantum states as input and performs a series of unitary operations controlled by adjustable parameters.

In one embodiment, training engine 204 then prepares the initial dataset. In one embodiment, training engine 204 encodes the data (whether classical or quantum) into the initial states of the quantum system. For example, in a classification task, labeled data might be encoded as quantum states representing each class.

In one embodiment, training engine 204 then defines the training loop, which involves iteratively adjusting the model's parameters to minimize the custom quantum loss function. In one embodiment, in quantum machine learning, a hybrid quantum-classical optimization loop is utilized, where the quantum circuit calculates expectation values or probability distributions, which are then fed into a classical optimizer that updates the circuit's parameters.

In one embodiment, training engine 204 then sets up the quantum environment, which includes selecting a quantum device (e.g., simulator or hardware) and configuring the necessary quantum machine learning library to interact with it.

Next, in one embodiment, training engine 204 trains and evaluates the model. During training, the model's performance is monitored based on the quantum information preserving loss function and other relevant metrics.

Upon training the model, the trained model produces a feature vector (numerical representation of the characteristics or properties of a data point), which is easily and effectively processed by the quantum computer (quantum computer 101) as well as preserves the important information and patterns present in the original classical feature vector. That is, the generated feature vector is not only compatible with quantum machines but also retains as much of the original data's meaning and relationships as possible after being transformed into a quantum state.

A further discussion regarding the approach of the quantum information preserving (QIP) loss function is discussed below.

Let x∈R^{h×x×c} denote the input image where h, w, and c are the image height, width, and number of channels correspondingly. Consider v=M(x) are the deep features extracted by a model [symbol] . Let [symbol] be the function to measure the gap of information between classical vector v and its corresponding quantum vector q. The goal of minimizing the quantum information gap (gap of information between classical and corresponding quantum features) may be represented as follows:

$$min ( v , q ) = ( ( x ) , ( ( x ) , ℰ , 𝒪 ) ) w . r . t ℰ , 𝒪 and v = ( x ) \qquad ( 1 )$$

In equation (1), only [symbol] and [symbol] are considered trainable. In one embodiment, training [symbol] is focused since q= [symbol] , indicating that [symbol] initiates the quantum encoding process, making it a critical component to address. Let [symbol] represent the task-specific layer to train the feature representation of x. [symbol] can be optimized with the objective function as in Eqn. (2).

$$= arg {𝔼}_{{x}_{i} \sim p ( {x}_{i} )} [ ℒ ( ( ( {x}_{i} ) ) , \hat{y} ) ] \qquad ( 2 )$$

Here, [symbol] and [symbol] denote the ground truth and the loss function, respectively. In one embodiment, one approach is to design [symbol] as a fully connected layer and employ loss functions, such as cross-entropy or metric losses for training a classification model. In one embodiment, cross-entropy is selected as [symbol] . It is noted that, however, [symbol] is also applicable to metric loss functions, such as ArcFace or CosFace.

$$ℒ = - \frac{1}{N} {\sum }_{i = 1}^{N} log \frac{{e}^{{w}_{{\hat{y}}_{i}}^{T} {v}_{i} + {b}_{j}}}{{\sum }_{j = 1}^{C} {e}^{{w}_{j}^{T} {v}_{i} + {b}_{j}}} \qquad ( 3 )$$

where Wⱼ∈R^{d} denotes the j^{th} column of the weight W∈R^{d×C}. C is the number of classes and bⱼ∈R is the bias term. For simply, bⱼ is fixed to equal 0. The equation turns out

$$ℒ = - \frac{1}{N} {\sum }_{i = 1}^{N} log \frac{{e}^{{w}_{{\hat{y}}_{i}}^{T} {v}_{i}}}{{\sum }_{j = q}^{C} {e}^{{w}_{j}^{T} {v}_{i}}} . \qquad ( 4 )$$

Wⱼ represents a center vector corresponding to class j. The loss function [symbol] optimizes model [symbol] so that the vector vᵢ aligns closely with Wⱼ if they belong to the same class in the feature space. Moreover,

$${W}_{i}^{T} v$$

signifies the cosine distance between the two vectors since these features are normalized, which precisely fulfills the roles of |ψ₁ [symbol] and |ψ₂ [symbol] in Proposition 1 (Consider two different quantum state vectors, denoted as |ψ₁ [symbol] and |ψ₂ [symbol] , and these corresponding quantum information vectors q₁ and q₂. [symbol] ψ₁|ψ₂ [symbol] /q^{T}q₂ for any Pauli observable and quantum encoding strategies). Leveraging this elegant property, [symbol] is defined as the Kullback-Leibler divergence (KL) to minimize the information gap as formulated in Eqn. (1) as follows:

$$\begin{matrix}= \frac{1}{N} {\sum }_{i = 1}^{N} KL ( {W}^{T} {v}_{i} , {S}^{T} {q}_{i} ) \\ = \frac{1}{N} {\sum }_{i = 1}^{N} {\sum }_{j = 1}^{N} {softmax ( {W}^{T} {v}_{i} )}_{j} \times log \frac{{softmax ( {W}^{T} {v}_{i} )}_{j}}{{softmax ( {S}^{T} {q}_{i} )}_{j}}\end{matrix} \qquad ( 5 )$$

where Sⱼ is the corresponding quantum information vector of Wⱼ using the following equation:

$$q = ( v , ℰ , 𝒪 ) \qquad ( 6 )$$

where Q is defined as the function to map v→q, where V is the classical information vector and q is the quantum information vector.

As a result of the foregoing, a novel loss function, referred to herein as the quantum information preserving loss function is developed to train [symbol] as follows:

$$= arg {𝔼}_{{x}_{i} \sim p ( {x}_{i} )} [ - log \frac{{e}^{{w}_{{\hat{y}}_{i}}^{T} {v}_{i}}}{{\sum }_{j = 1}^{C} {e}^{{w}_{j}^{T} {v}_{i}}} + λ \times KL ( {W}^{T} {v}_{i} , {S}^{T} {q}_{i} ) ] \qquad ( 7 )$$

where λ is the loss factor for controlling how much information is preserved. Using this loss function, the model [symbol] can produce the feature V, which retains as much of the original data's meaning and relationships as possible after quantum encoding.

A pseudo-code of the algorithm (Algorithm 1) implementing the quantum information preventing loss function discussed herein is provided below:

Algorithm 1: Pseudo-code for the implementation of Quantum
Information Preserving Loss

Data:
${\{ {x}_{i} \}}_{i = 1}^{N} ∈ {ℝ}^{N \times h \times ω \times c} : a set of N input images$
${\{ {\hat{y}}_{i} \}}_{i = 1}^{N} ∈ {ℝ}^{N} : a set of N labels$ [symbol]
: feature extractor [symbol]
: trainable parameters of [symbol] [symbol]
: learning rate of [symbol]
λ: loss factor of Quantum Information Preserving loss
while not convergent do
vᵢ ← [symbol] (xᵢ) / / Extract classical features of the images
qᵢ ← [symbol] (vᵢ, [symbol] ) / / Transform into quantum features as Eqn. (6)
S ← [symbol] (W, [symbol] ) / / Transform into quantum center vectors
wᵢ ← softmax(W^{T} vᵢ) / / Project classical features into logits
uᵢ ← softmax(S^{T} qᵢ) / / Project quantum features into logits
$ℒ ← \frac{1}{N} {\sum }_{i = 1}^{N} - log {ω}_{i , {\hat{y}}_{i}} // Apply metric loss as Eqn . ( 3 )$
$← \frac{1}{N} {\sum }_{i = 1}^{N} {\sum }_{j = 1}^{C} {ω}_{i , j} log \frac{{ω}_{i , j}}{{u}_{i , j}} // Apply KL divergence as Eqn . ( 5 )$ [symbol]
_{QIP} ← [symbol] + λ [symbol] / / Compute the Quantum Information Preserving Loss [symbol]
← [symbol] − [symbol] / / Do backpropagation
end

In this manner, the quantum information gap is minimized via the quantum information preserving loss function of the present disclosure.

A further description of these and other functions is provided below in connection with the discussion of the method for minimizing the quantum information gap (gap of information between classical and corresponding quantum features) using a loss function (referred to herein as the quantum information preserving loss function).

Prior to the discussion of the method for minimizing the quantum information gap (gap of information between classical and corresponding quantum features) using a loss function (referred to herein as the quantum information preserving loss function), a description of the hardware configuration of classical computer 102 (FIG. 1) is provided below in connection with FIG. 3.

Referring now to FIG. 3, in conjunction with FIG. 1, FIG. 3 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code 301 involved in performing the inventive methods, such as minimizing the quantum information gap (gap of information between classical and corresponding quantum features) using the quantum information preserving loss function of the present disclosure. In addition to block 301, computing environment 300 includes, for example, classical computer 102, network 113, such as a wide area network (WAN), end user device (EUD) 302, remote server 303, public cloud 304, and private cloud 305. In this embodiment, classical computer 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically classical computer 102, to keep the presentation as simple as possible. Classical computer 102 may be located in a cloud, even though it is not shown in a cloud in FIG. 3. On the other hand, classical computer 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto classical computer 102 to cause a series of operational steps to be performed by processor set 306 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 310 is located in a single package and is internal to classical computer 102, but, alternatively or additionally, the volatile memory may be distributed over multiple packages and/or located externally with respect to classical computer 102.

Persistent Storage 311 is any form of non-volatile storage for computers that is now known or to be developed in the future. The non-volatility of this storage means that the stored data is maintained regardless of whether power is being supplied to classical computer 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows classical computer 102 to communicate with other computers through WAN 113. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to classical computer 102 from an external computer or external storage device through a network adapter card or network interface included in network module 317.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates classical computer 102), and may take any of the forms discussed above in connection with classical computer 102. EUD 302 typically receives helpful and useful data from the operations of classical computer 102. For example, in a hypothetical case where classical computer 102 is designed to provide a recommendation to an end user, this recommendation would typically be communicated from network module 317 of classical computer 102 through WAN 113 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to classical computer 102. Remote server 303 may be controlled and used by the same entity that operates classical computer 102. Remote server 303 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to minimize the quantum information gap (gap of information between classical and corresponding quantum features) using a loss function (referred to herein as the quantum information preserving loss function). In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for minimizing the quantum information gap (gap of information between classical and corresponding quantum features) using a loss function (referred to herein as the quantum information preserving loss function), may be embodied in an application-specific integrated circuit.

As stated above, due to the substantial collaborative endeavors of academia and industry, contemporary quantum devices, often referred to as noisy intermediate-scale quantum (NISQ) devices, are now capable of demonstrating quantum advantages in specific meticulously crafted tasks. Emerging research focuses in leveraging near-term quantum devices for practical machine learning applications, with a prominent approach being hybrid quantum-classical algorithms, also referred to as variational quantum algorithms. These algorithms typically employ a classical optimizer to refine quantum neural networks (QNNs) by allocating complex tasks to quantum computers while assigning simpler tasks to classical computers. In typical quantum machine learning scenarios, a quantum circuit utilized in variational quantum algorithms is commonly divided into two components: a data encoding circuit and a QNN. Enhancing these algorithms' efficacy in handling practical tasks involves the development of various QNN architectures. Numerous architectures, including strongly entangling circuit architectures, tree-tensor networks, quantum convolutional neural networks, and even automatically searched architectures, have been proposed. Furthermore, enhancing the algorithms' efficiency in handling practical tasks involves the careful design of the encoding circuit as it can significantly impact the generalization performance of these algorithms. Encoding classical information into quantum data is a crucial step as it directly impacts the performance of quantum machine learning algorithms. These algorithms are designed to optimize objective functions, such as classification, using encoded data. However, quantum encoding poses significant challenges, especially on near-term quantum devices, as highlighted in previous research. While phase and amplitude encoding are foundational approaches, recent advancements have popularized parameterized quantum circuits (PQCs) as the most practical strategy for encoding on NISQ devices. Nevertheless, despite the prevalence of PQCs, it is essential to utilize the basic encoding methods, such as phase and amplitude encoding, at the first step due to simplicity and accessibility, reduced hardware demands, and targeted encoding. Phase and amplitude encoding are fundamental techniques in quantum computing for representing classical data into quantum states, which is referred to as “quantum encoding.” Quantum encoding is the process of transforming classical data (e.g., numbers, text, images) into a quantum state, which is a superposition of 0s and 1s represented by qubits. These encodings (phase and amplitude encoding) leverage the properties of quantum superposition and entanglement to potentially offer advantages in computational speed and efficiency compared to classical methods. Unfortunately, such encoding strategies (e.g., phase and amplitude encoding) when used in connection with quantum visual encoding, which focuses on transforming complex visual data into a form that can be effectively processed by quantum algorithms, fail to guarantee the preserving of the fundamental properties or characteristics of the classical data in its quantum form. That is, existing quantum encoding strategies (e.g., phase and amplitude encoding) fail to ensure information preservation of the visual features after the encoding process, thus complicating the learning process of the quantum machine learning models resulting in a quantum information gap (QIG), i.e., a gap of information between classical and corresponding quantum features.

The embodiments of the present disclosure provide an efficient new loss function (referred to herein as the “quantum information preserving (QIP) loss function”) to minimize the quantum information gap resulting in enhanced performance of quantum machine learning algorithms as discussed below in connection with FIG. 4.

FIG. 4 is a flowchart of a method 400 for minimizing the quantum information gap in accordance with an embodiment of the present disclosure.

Referring to FIG. 4, in conjunction with FIGS. 1-3, in step 401, transformation engine 201 receives a set of images.

As stated above, in one embodiment, the images include photographs, videos, or combinations thereof. In one embodiment, the images include facial expressions. In one embodiment, the images include a landscape. In one embodiment, the set of images is captured through a camera

In step 402, transformation engine 201 extracts the classical features (vi) from the set of images.

As discussed above, classical features, as used herein, refer to the characteristics (e.g., edges, textures, shapes, corners, etc.) captured from the set of images.

In one embodiment, transformation engine 201 extracts such classical features using the histogram of oriented gradients, which captures the distribution of edge orientations to represent shape and appearance. In one embodiment, such a process involves dividing the images into cells, computing gradients, creating orientation histograms, and normalizing them in blocks to form a feature vector.

In another embodiment, transformation engine 201 extracts such classical features using local binary patterns, which describe local texture patterns. In one embodiment, such a process involves comparing a center pixel to its neighbors, assigning binary values, converting patterns to decimal numbers, and creating a histogram.

In another embodiment, transformation engine 201 extracts such classical features using a gray level co-occurrence matrix, which analyzes spatial relationships between pixels by counting intensity value pairs at defined distances and angles. In one embodiment, such a process involves converting the image to grayscale, creating and normalizing a co-occurrence matrix, and extracting the statistical features (e.g., contrast, energy).

In a further embodiment, transformation engine 201 extracts such classical features using a scale-invariant feature transform (SIFT) and speeded-up robust features (SURF), which are algorithms that detect and describe local features (keypoints) resistant to scale, rotation, and illumination changes. In one embodiment, such a process involves detecting keypoints, assigning orientation, creating descriptors, and matching descriptors between images.

In step 403, transformation engine 201 transforms the extracted classical features into quantum features (qᵢ). Quantum features, as used herein, refer to the unique characteristics of the quantum mechanical realm, including wave-particle duality, superposition, entanglement, and quantized energy levels.

As stated above, in one embodiment, transformation engine 201 transforms the extracted classical features into quantum features by utilizing a quantum feature map, which is a quantum circuit designed to encode classical data into quantum states. In one embodiment, transformation engine 201 utilizes the basis encoding scheme, which represents each feature with a qubit, mapping binary features directly to computational basis states (e.g., 0 to |0>, 1 to |1>).

In one embodiment, transformation engine 201 utilizes the amplitude encoding scheme, which encodes the classical feature vector into the amplitudes of the quantum state.

In another embodiment, transformation engine 201 utilizes the angle encoding scheme, which uses rotation gates (Rx, Ry, Rz) where the rotation angles are determined by the classical feature values.

In a further embodiment, transformation engine 201 utilizes parameterized quantum circuits, which utilize trainable unitary transformations to evolve quantum states, capturing complex feature relationships and representing data in high-dimensional quantum spaces.

In one embodiment, transformation engine 201 then builds the quantum circuit, such as by selecting the appropriate gates and sequencing them to implement the chosen encoding scheme. Transformation engine 201 may utilize various software tools for building the quantum circuit, including, but not limited to, Qiskit®, PennyLane®, Cirq®, etc.

In one embodiment, transformation engine 201 transforms the extracted classical features into quantum features (qᵢ) by performing [symbol] (vᵢ, [symbol] ), where it defines a function Q that maps a classical data point v into a quantum feature q, represented by a quantum state in Hilbert space. The parameters [symbol] and [symbol] represent the encoding strategy or the specific quantum operations used for the transformation.

In step 404, transformation engine 201 transforms the extracted classical features into quantum center vectors. Quantum center vectors, as used herein, refer to elements within the center of a quantum algebra or quantum group.

As discussed above, transformation engine 201 transforms the extracted classical features into quantum center vectors by utilizing kernel-based quantum machine learning. For example, quantum features may be represented and leveraged through quantum kernel methods. Quantum kernels measure the similarity between quantum states.

In one embodiment, transformation engine 201 implements a kernel trick which allows calculating these similarities (inner products) in a high-dimensional quantum feature space without explicitly computing the coordinates of each quantum state.

In one embodiment, transformation engine 201 then implements a quantum kernel estimation, which involves estimating the values of the quantum kernel function using quantum circuits, for example, using a sweep test or Hadamard test to measure the overlap between quantum states.

In one embodiment, transformation engine 201, within this framework, defines the quantum center vectors as the centroids of clusters or the representatives of different classes in the quantum feature space. These are then used in quantum clustering or classification algorithms.

In one embodiment, transformation engine 201 transforms the extracted classical features into quantum center vectors (S) by performing [symbol] (W, [symbol] ) using the same Q function. In one embodiment, W refers to a set of weights or parameters used to define these center vectors in the classical domain before they are transformed into quantum features.

In step 405, projecting engine 202 projects the classical features into logits (raw prediction scores). Logits, as used herein, refer to the raw, unnormalized scores from the model, representing the model's initial predictions before being transformed into probabilities.

As stated above, in one embodiment, projecting engine 202 projects the classical features into logits (wᵢ) by applying a linear transformation (W^{T}) of the classical features (vᵢ) and then normalizing them using the Softmax function. In one embodiment, W represents a weight matrix (or a set of weights) that the model learns during training. In one embodiment, the linear transformation involves matrix multiplication effectively combining the input features with the learned weights to produce raw scores (logits) for each possible class. In one embodiment, the softmax function converts these logits into a probability distribution over the classes. In one embodiment, the outputs are between 0 and 1 and sum up to 1, representing the probability of the input belonging to each class.

In step 406, projecting engine 202 projects the quantum features (qᵢ) into logits (uᵢ) using the quantum center vectors(S).

As discussed above, in one embodiment, projecting engine 202 performs the calculation (S^{T} qᵢ), such an inner product calculation, between the quantum center vectors(S) and the quantum feature of the input qᵢ to measure the similarity or closeness of the input data point's quantum features to each of the quantum center vectors.

In one embodiment, projecting engine 202 feeds the result of (S^{T} qᵢ) into a Softmax function, which converts a set of scores (logits, which are the outputs of (S^{T} qᵢ)) into a probability distribution, where each value represents the probability that the input vᵢ belongs to one of the classes based on its similarity to the corresponding quantum center vector. The output uᵢ will be a vector of these probabilities.

In step 407, calculating engine 203 calculates a loss function ( [symbol] ) measuring how well a model's predictions align with the true labels using the logits (wᵢ) of the classical features and a set of labels ( [symbol] ).

As stated above, true labels, as used herein, refer to the actual correct classifications or values associated with each data point in a dataset. In one embodiment, calculating engine 203 calculates such a loss function ( [symbol] ) by computing the following equation:

$$\frac{1}{N} {\sum }_{i = 1}^{N} - log {w}_{i} , {\hat{y}}_{i} .$$

In one embodiment,

$$- log {w}_{i} , {\hat{y}}_{i} .$$

is the negative logarithm of the predicted probability for the correct class ( [symbol] ) for the i-th image. That is, if the model predicts the correct class with high probability (closer to 1), then-log (probability) will be close to 0 (lower loss). In contrast, if the model predicts the correct class with low probability, then the loss will be high.

In one embodiment, calculating engine 203 computes the average of the negative log-probabilities over all N samples.

In one embodiment, the cross-entropy loss (the loss computed using the negative logarithm of the predicted probabilities) is used to quantify the error between the predictions and the actual labels thereby aiming to minimize this loss during training.

In step 408, calculating engine 203 calculates an expression ( [symbol] ) that minimizes an average Kullback-Leibler (KL) divergence between the projected feature distributions from two different modalities or sources using the logits (wᵢ) of the classical features and the logits (uᵢ) of the quantum features.

As discussed above, in one embodiment, such an expression is computed by calculating engine 203 using the following formula:

$$← \frac{1}{N} {\sum }_{i = 1}^{N} {\sum }_{\vert j = 1}^{C} {w}_{i , j} log \frac{{w}_{i , j}}{{w}_{i , j}} .$$

In one embodiment, the KL divergence measures how one probability distribution differs from a second, reference probability distribution. For example, such probability distributions correspond to wᵢ and uᵢ.

Furthermore, calculating engine 203 performs an averaging operation over N samples or instances as well as indicates a summation over c classes or categories within each sample's probability distribution.

Additionally, calculating engine 203 calculates the average KL divergence over a dataset (i=1 to N). In one embodiment, calculating engine 203 compares the probability distribution produced by applying the softmax function to a set of learned weights (W^{T}vᵢ) with a reference probability distribution derived from the quantum information vectors (S^{T}qᵢ). By minimizing the KL divergence, the model aims to make its predicted distribution as close as possible to the target distribution (Q), which is influenced by the quantum information vectors derived from Wⱼ. That is, the model is attempting to align its classical machine learning predictions with the quantum properties represented by Sⱼ and Wᵢ.

In step 409, calculating engine 203 computes a quantum information preserving loss function ( [symbol] |_{QIP}) to train a model to minimize the quantum information gap using the loss function ( [symbol] ), the expression ( [symbol] ), and the loss factor for controlling how much information is preserved.

As stated above, in one embodiment, the quantum information preserving loss function is calculated using the following:

$$\frac{1}{N} {\sum }_{i = 1}^{N} - log {w}_{i} , {\hat{y}}_{i} .$$

In one embodiment, calculating engine 203 computes a quantum information preserving loss function ( [symbol] |_{QIP}) using the components of the metric loss [symbol] and the scaled KL divergence λ [symbol] .

As a result, the quantum information preserving loss function aims to optimize the model's performance in two ways: metric matching and quantum information preservation. Metric matching involves the metric loss term which ensures that the model's predictions align with the true labels. Quantum information preservation involves the KL divergence term, which encourages the model to maintain a resemblance to a predefined “quantum information preserving” distribution represented by Sⱼ.

In one embodiment, the weighting factor, λ, controls the balance between these two objectives.

In step 410, training engine 204 trains the model to minimize the quantum information gap using the quantum information preserving loss function.

In one embodiment, training engine 204 defines a quantum model. In one embodiment, the quantum model is defined by constructing a parameterized quantum circuit or a variational quantum neural network using a library, such as PennyLane®, Qiskit®, Cirq®, etc. In one embodiment, the model takes quantum states or classical data encoded as quantum states as input and performs a series of unitary operations controlled by adjustable parameters.

In one embodiment, training engine 204 then prepares the initial dataset. In one embodiment, training engine 204 encodes the data (whether classical or quantum) into the initial states of the quantum system. For example, in a classification task, labeled data might be encoded as quantum states representing each class.

In one embodiment, training engine 204 then defines the training loop, which involves iteratively adjusting the model's parameters to minimize the custom quantum loss function. In one embodiment, in quantum machine learning, a hybrid quantum-classical optimization loop is utilized, where the quantum circuit calculates expectation values or probability distributions, which are then fed into a classical optimizer that updates the circuit's parameters.

In one embodiment, training engine 204 then sets up the quantum environment, which includes selecting a quantum device (e.g., simulator or hardware) and configuring the necessary quantum machine learning library to interact with it.

Next, in one embodiment, training engine 204 trains and evaluates the model. During training, the model's performance is monitored based on the quantum information preserving loss function and other relevant metrics.

Upon training the model, the trained model produces a feature vector (numerical representation of the characteristics or properties of a data point), which is easily and effectively processed by the quantum computer (quantum computer 101) as well as preserves the important information and patterns present in the original classical feature vector. That is, the generated feature vector is not only compatible with quantum machines but also retains as much of the original data's meaning and relationships as possible after being transformed into a quantum state.

In this manner, the quantum information gap (gap of information between classical and corresponding quantum features) is minimized using the loss function (referred to herein as the quantum information preserving loss function) of the present disclosure.

Furthermore, the principles of the present disclosure improve the technology or technical field involving quantum encoding.

As discussed above, due to the substantial collaborative endeavors of academia and industry, contemporary quantum devices, often referred to as noisy intermediate-scale quantum (NISQ) devices, are now capable of demonstrating quantum advantages in specific meticulously crafted tasks. Emerging research focuses in leveraging near-term quantum devices for practical machine learning applications, with a prominent approach being hybrid quantum-classical algorithms, also referred to as variational quantum algorithms. These algorithms typically employ a classical optimizer to refine quantum neural networks (QNNs) by allocating complex tasks to quantum computers while assigning simpler tasks to classical computers. In typical quantum machine learning scenarios, a quantum circuit utilized in variational quantum algorithms is commonly divided into two components: a data encoding circuit and a QNN. Enhancing these algorithms' efficacy in handling practical tasks involves the development of various QNN architectures. Numerous architectures, including strongly entangling circuit architectures, tree-tensor networks, quantum convolutional neural networks, and even automatically searched architectures, have been proposed. Furthermore, enhancing the algorithms' efficiency in handling practical tasks involves the careful design of the encoding circuit as it can significantly impact the generalization performance of these algorithms. Encoding classical information into quantum data is a crucial step as it directly impacts the performance of quantum machine learning algorithms. These algorithms are designed to optimize objective functions, such as classification, using encoded data. However, quantum encoding poses significant challenges, especially on near-term quantum devices, as highlighted in previous research. While phase and amplitude encoding are foundational approaches, recent advancements have popularized parameterized quantum circuits (PQCs) as the most practical strategy for encoding on NISQ devices. Nevertheless, despite the prevalence of PQCs, it is essential to utilize the basic encoding methods, such as phase and amplitude encoding, at the first step due to simplicity and accessibility, reduced hardware demands, and targeted encoding. Phase and amplitude encoding are fundamental techniques in quantum computing for representing classical data into quantum states, which is referred to as “quantum encoding.” Quantum encoding is the process of transforming classical data (e.g., numbers, text, images) into a quantum state, which is a superposition of 0s and 1s represented by qubits. These encodings (phase and amplitude encoding) leverage the properties of quantum superposition and entanglement to potentially offer advantages in computational speed and efficiency compared to classical methods. Unfortunately, such encoding strategies (e.g., phase and amplitude encoding) when used in connection with quantum visual encoding, which focuses on transforming complex visual data into a form that can be effectively processed by quantum algorithms, fail to guarantee the preserving of the fundamental properties or characteristics of the classical data in its quantum form. That is, existing quantum encoding strategies (e.g., phase and amplitude encoding) fail to ensure information preservation of the visual features after the encoding process, thus complicating the learning process of the quantum machine learning models resulting in a quantum information gap (QIG), i.e., a gap of information between classical and corresponding quantum features.

Embodiments of the present disclosure improve such technology by minimizing the quantum information gap using an efficient new loss function, referred to herein as the quantum information preserving loss function. In one embodiment, classical features are extracted from a set of images (e.g., photographs, videos). The classical features are then transformed into quantum features and quantum center vectors. Quantum features refer to the unique characteristics of the quantum mechanical realm, including wave-particle duality, superposition, entanglement, and quantized energy levels. Quantum center vectors refer to elements within the center of a quantum algebra or quantum group. The classical features are then projected into logits. Logits refer to the raw, unnormalized scores from the model, representing the model's initial predictions before being transformed into probabilities. Furthermore, the quantum features are projected into logits using the quantum center vectors. In one embodiment, a loss function measuring how well a model's prediction aligns with true labels (the actual correct classifications or values associated with each data point in a dataset) is calculated using the logits of the classical features and a set of labels. Furthermore, an expression is calculated that minimizes an average Kullback-Leibler (KL) divergence between projected feature distributions from two different modalities or sources using the logits of the classical features and the logits of the quantum features. By minimizing the KL divergence, the model aims to make its predicted distribution as close as possible to the target distribution. That is, the model is attempting to align its classical machine learning predictions with the quantum properties. Additionally, the quantum information preserving loss function used to train a model to minimize the quantum information gap is calculated using the loss function, the expression, and a loss factor for controlling how much information is preserved. The quantum information preserving loss function aims to optimize the model's performance in two ways: metric matching and quantum information preservation. Metric matching involves the metric loss term which ensures that the model's predictions align with the true labels. Quantum information preservation involves the KL divergence term, which encourages the model to maintain a resemblance to a predefined “quantum information preserving” distribution. After training the model to minimize the quantum information gap using the quantum information preserving loss function, the trained model produces a feature vector (numerical representation of the characteristics or properties of a data point), which is easily and effectively processed by the quantum computer as well as preserves the important information and patterns present in the original classical feature vector. That is, the generated feature vector is not only compatible with quantum machines but also retains as much of the original data's meaning and relationships as possible after being transformed into a quantum state. In this manner, the quantum information gap (gap of information between classical and corresponding quantum features) is minimized using the loss function (referred to herein as the quantum information preserving loss function) of the present disclosure. Furthermore, in this manner, there is an improvement in the technical field involving quantum encoding.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for minimizing a quantum information gap, the method comprising:
receiving a set of images;
extracting classical features from said set of images;
transforming said classical features into quantum features;
transforming said classical features into quantum center vectors;
projecting said classical features into logits;
projecting said quantum features into logits using said quantum center vectors;
calculating a loss function measuring how well a model's prediction aligns with true labels using said logits of said classical features and a set of labels;
calculating an expression that minimizes an average Kullback-Leibler divergence between projected feature distributions from two different modalities or sources using said logits of said classical features and said logits of said quantum features; and
computing a quantum information preserving loss function to train a model to minimize said quantum information gap using said loss function, said expression, and a loss factor for controlling how much information is preserved.

2. The method as recited in claim 1 further comprising:
training said model to minimize said quantum information gap using said quantum information preserving loss function.

3. The method as recited in claim 2, wherein said trained model produces a feature vector.

4. The method as recited in claim 1, wherein said set of images comprises photographs, videos, or combinations thereof.

5. The method as recited in claim 1, wherein said set of images comprises facial expressions.

6. The method as recited in claim 1, wherein said set of images comprises a landscape.

7. The method as recited in claim 1, wherein said set of images is captured through a camera.

8. A computer program product for minimizing a quantum information gap, the computer program product comprising one or more computer readable storage mediums having program code embodied therewith, the program code comprising programming instructions for:
receiving a set of images;
extracting classical features from said set of images;
transforming said classical features into quantum features;
transforming said classical features into quantum center vectors;
projecting said classical features into logits;
projecting said quantum features into logits using said quantum center vectors;
calculating a loss function measuring how well a model's prediction aligns with true labels using said logits of said classical features and a set of labels;
calculating an expression that minimizes an average Kullback-Leibler divergence between projected feature distributions from two different modalities or sources using said logits of said classical features and said logits of said quantum features; and
computing a quantum information preserving loss function to train a model to minimize said quantum information gap using said loss function, said expression, and a loss factor for controlling how much information is preserved.

9. The computer program product as recited in claim 8, wherein the program code further comprises the programming instructions for:
training said model to minimize said quantum information gap using said quantum information preserving loss function.

10. The computer program product as recited in claim 9, wherein said trained model produces a feature vector.

11. The computer program product as recited in claim 8, wherein said set of images comprises photographs, videos, or combinations thereof.

12. The computer program product as recited in claim 8, wherein said set of images comprises facial expressions.

13. The computer program product as recited in claim 8, wherein said set of images comprises a landscape.

14. The computer program product as recited in claim 8, wherein said set of images is captured through a camera.

15. A system, comprising:
a memory for storing a computer program for minimizing a quantum information gap; and
a processor connected to said memory, wherein said processor is configured to execute program instructions of the computer program comprising:
receiving a set of images;
extracting classical features from said set of images;
transforming said classical features into quantum features;
transforming said classical features into quantum center vectors;
projecting said classical features into logits;
projecting said quantum features into logits using said quantum center vectors;
calculating a loss function measuring how well a model's prediction aligns with true labels using said logits of said classical features and a set of labels;
calculating an expression that minimizes an average Kullback-Leibler divergence between projected feature distributions from two different modalities or sources using said logits of said classical features and said logits of said quantum features; and
computing a quantum information preserving loss function to train a model to minimize said quantum information gap using said loss function, said expression, and a loss factor for controlling how much information is preserved.

16. The system as recited in claim 15, wherein the program instructions of the computer program further comprise:
training said model to minimize said quantum information gap using said quantum information preserving loss function.

17. The system as recited in claim 16, wherein said trained model produces a feature vector.

18. The system as recited in claim 15, wherein said set of images comprises photographs, videos, or combinations thereof.

19. The system as recited in claim 15, wherein said set of images comprises facial expressions.

20. The system as recited in claim 15, wherein said set of images comprises a landscape.
